(19) United States
(12) Patent Application Publication
(10) Pub. No.: US 2026/0110788 A1
(43) Pub. Date: Apr. 23, 2026

(54) WIDE BANDWIDTH DUAL-MODE SONAR TRANSDUCER WITH CONTROLLABLE RESONANCE FREQUENCIES

(71) Applicant: Amphenol (Maryland), Inc., Frederick, MD (US)

(72) Inventor: Alex MEZHERITSKY, Indianapolis, IN (US)

(21) Appl. No.: 19/356,428

(22) Filed: Oct. 13, 2025

Related U.S. Application Data
(60) Provisional application No. 63/710,678, filed on Oct. 23, 2024.

(51) Int. Cl. G01S 7/521; B06B 1/06

(52) U.S. Cl. CPC G01S 7/521; B06B 1/0614; B06B 1/0618; B06B 2201/74

(57) ABSTRACT

A sonar transducer includes an acoustic radiating piston, a piezoelectric stack, and a non-uniform central fastener. The acoustic radiating piston emits and receives acoustic waves. The piezoelectric stack includes a plurality of piezoelectric elements. The piezoelectric stack converts output electrical signals into mechanical vibrations and converts received mechanical vibrations into input electrical signals. The non-uniform central fastener has a body extending from a first end to a second end to define a fastener length. The non-uniform central fastener extends through the piezoelectric stack and applies a pre-stress to the piezoelectric stack. The non-uniform central fastener has a non-uniform profile along the fastener length.

### CROSS REFERENCE TO RELATED APPLICATIONS

This application claims the benefit of U.S. Provisional Application No. 63/710,678, filed October 23, 2024, the contents of which are incorporated by reference in their entirety herein.

### BACKGROUND

Exemplary embodiments of the present disclosure relate to transduction structures, more particularly, to a wide bandwidth dual-mode sonar transducer with controllable resonance frequencies.

Electro-acoustic underwater transducers such a sonar transducers, for example, are operated in a narrow vicinity of the fundamental resonant frequency. Maximum output is obtained at the resonant frequency. However, operation in the vicinity of this frequency limits the bandwidth of the transducer. Wideband performance can be obtained above resonance, but the operating band is often limited by the next overtone resonance (e.g., the 2nd resonance frequency) in the near symmetric transducer structure. Because of phase shifts, the presence of this overtone resonance generally creates a cancellation between the two resonant frequencies typically resulting in a significant reduction in the level of the response, thus limiting the bandwidth.

### SUMMARY

A sonar transducer includes an acoustic radiating piston, a piezoelectric stack, and a non-uniform central fastener. The acoustic radiating piston emits and receives acoustic waves. The piezoelectric stack includes a plurality of piezoelectric elements. In typical arrangements, a piezoelectric stack includes one or several piezoelectric elements, stacked together with conductive (metal) shims. The piezoelectric elements can be in ring or cylinder shape. The shims provide connection of electrical source/voltage to each and all piezoelectric elements. The piezoelectric stack converts output electrical signals into mechanical vibrations and converts received mechanical vibrations into input electrical signals.

The non-uniform central fastener has a body extending from a first end to a second end to define a fastener length. The non-uniform central fastener extends through the piezoelectric stack and applies a pre-stress to the piezoelectric stack. The non-uniform central fastener has a non-uniform profile along the fastener length.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1A is a block diagram depicting a separated view of a sonar transducer according to a non-limiting embodiment of the present disclosure;

FIG. 1B is an assembled view of the sonar transducer shown in FIG. 1A according to a non-limiting embodiment of the present disclosure;

FIG. 2A is a block diagram of a first machined non-uniform central fastener according to a non-limiting embodiment of the present disclosure;

FIG. 2B is a block diagram of a second machined non-uniform central fastener according to a non-limiting embodiment of the present disclosure;

FIG. 2C is a block diagram of a third machined non-uniform central fastener according to a non-limiting embodiment of the present disclosure;

FIG. 2D is a block diagram of a first sectioned non-uniform central fastener according to a non-limiting embodiment of the present disclosure;

FIG. 2E is a block diagram of a second sectioned non-uniform central fastener according to a non-limiting embodiment of the present disclosure;

FIG. 2F is a block diagram of a third sectioned non-uniform central fastener according to a non-limiting embodiment of the present disclosure;

FIG. 2G is a block diagram of a separated non-uniform central fastener according to a non-limiting embodiment of the present disclosure;

FIG. 2H depicts a three-dimensional (3D) finite element analysis (FEA) simulation data for first and second resonance frequencies vs. a center groove and lateral flanges;

FIG. 3A is a block diagram of an assembled sonar transducer implementing the first machined non-uniform central fastener according to a non-limiting embodiment of the present disclosure;

FIG. 3B is a block diagram of an assembled sonar transducer implementing the second machined non-uniform central fastener according to a non-limiting embodiment of the present disclosure;

FIG. 3C is a block diagram of an assembled sonar transducer implementing the third machined non-uniform central fastener according to a non-limiting embodiment of the present disclosure;

FIG. 3D is a block diagram of an assembled sonar transducer implementing the first sectioned non-uniform central fastener according to a non-limiting embodiment of the present disclosure;

FIG. 3E is a block diagram of an assembled sonar transducer implementing the second sectioned non-uniform central fastener according to a non-limiting embodiment of the present disclosure;

FIG. 3F is a block diagram of an assembled sonar transducer implementing the third sectioned non-uniform central fastener according to a non-limiting embodiment of the present disclosure;

FIG. 3G is a block diagram of an assembled sonar transducer implementing the separated non-uniform central fasteners according to a non-limiting embodiment of the present disclosure;

FIG. 4A is a sideview of a fabricated a profile central bolt including a groove located at the first fundamental sonar node according to a non-limiting embodiment of the present disclosure;

FIG. 4B is a sideview of a fabricated a profile central bolt including a groove located at the first fundamental sonar node and opposing flanges located at second resonance nodes, according to a non-limiting embodiment of the present disclosure;

FIG. 5A is a perspective view of a sonar transducer implementing a non-uniform central fastener according to a non-limiting embodiment of the present disclosure; and with a circular radiating plate;

FIG. 5B is a perspective view of a sonar transducer implementing a non-uniform central fastener according to a non-limiting embodiment of the present disclosure according to another non-limiting embodiment of the present disclosure with a square radiating plate;

FIG. 6A is a diagram illustrating the stress-displacement characteristic with respect to a node located at the sonar fundamental lowest resonance with a vibrating central fastener included in a sonar transducer according to a non-limiting embodiment of the present disclosure;

FIG. 6B is a diagram illustrating the stress-displacement characteristic with respect to nodes located at the sonar second resonance with a vibrating central fastener included in a sonar transducer according to a non-limiting embodiment of the present disclosure;

FIG. 7 is a block diagram illustrating a physical model of a sonar transducer according to a non-limiting embodiment of the present disclosure;

FIGS. 8 is a transducer Voltage Response (TVR) wave diagram illustrating bandwidth widening effect provided by a sonar transducer according to a non-limiting embodiment of the present disclosure.

### DETAILED DESCRIPTION

A detailed description of one or more embodiments of the disclosed apparatus and method are presented herein by way of exemplification and not limitation with reference to the Figures.

Sonar transducers are often designed as pre-stressed piezoelectric transducers, also referred to as “Tonpilz transducers”, which are designed for underwater acoustics applications such as sonar systems that require high power, sensitivity and efficiency. The architecture of a pre-stressed piezoelectric transducer optimizes the conversion of electrical energy into acoustic energy and vice versa, making it ideal for applications like submarine sonar, depth sounding, and underwater communication.

A pre-stressed piezoelectric transducer implements an assembly of components, including an acoustic radiating piston, a head mass, a piezoelectric stack, a tail mass, and a uniform metal central rod (sometimes referred to a bolt).

The acoustic radiating piston (sometimes referred to as a “membrane”) may be formed from metals such as aluminum or titanium, for example, and serves as the primary radiating surface, typically directly or through an acoustical matching layer, which emits sound waves to a surrounding load such as a fluid (e.g., water) or gas (e.g., air). The piezoelectric stack includes a stack of ceramic elements such as lead zirconate titanate (PZT), for example, which deform when an electric voltage is applied to produce mechanical vibrations. The head mass and the tail mass may be constructed from denser materials such as steel or tungsten, for example, and serve as a counterbalance, reflecting energy back into the piezoelectric stack to provide resonance tuning and enhance acoustic output. The central rod extends through the assembly to fasten and compress the head mass, the piezoelectric stack, and the tail mass together. The central rod used in a conventional piezoelectric transducer has a uniform profile (e.g., a uniform shape, a uniform material, and a uniform stiffness) that extends along its length, which facilitates energy transfer and allows the transducer to operate at its resonant frequency.

The uniform central rod and a single piezoelectric element are typically located at the center of the piezoelectric transducer. This design exhibits left-right (axial) symmetry, which significantly influences the vibrational modes, or harmonics, which are piezoelectrically active and effectively excited or sensed by the piezoelectric element. Specifically, only the odd-numbered harmonics, such as the fundamental mode and the third harmonic, are active in this configuration. This is because the displacement patterns of odd harmonics are symmetric about the center, aligning with the placement of the central piezoelectric element and allowing efficient coupling between electrical and mechanical energy. The frequency ratio between the fundamental frequency and the third harmonic is approximately 1:3, which is a characteristic of systems where odd harmonics dominate due to symmetry.

Even-numbered harmonics, like the second resonance, are not piezoelectrically active in conventional pre-stressed piezoelectric transducers because their displacement patterns are antisymmetric about transducer’s center. In such cases, the positive and negative displacements cancel out, resulting in zero net electrical output or input.

Attempted solutions to activate these even harmonics have involved introducing piezoelectric asymmetry using two piezoelectric stacks with different configurations. For example, a first piezoelectric stack is configured with high capacitance (e.g., using a ring stack), while a second piezoelectric stack is configured with a low capacitance (e.g., using a monolithic cylinder). This asymmetry allows the transducer to couple with the antisymmetric displacement patterns of even harmonics, making them piezoelectrically active.

However, while the use of two different piezoelectric stacks can adjust the relative intensities or amplitudes of the resonance frequencies by enhancing or suppressing certain modes, it does not alter the actual frequencies at which these resonances occur. The resonant frequencies are primarily determined by the physical dimensions and material properties of the transducer components, such as the masses and stiffness of the head and tail masses. Therefore, while altering the configurations of the piezoelectric stacks may change intensities of the relative resonance frequencies, it does not allow for changing or controlling disposition of the relative frequencies, i.e., the specific frequencies at which the resonant modes of a sonar transducer occur and their positions relative to each other on the frequency spectrum.

Various non-limiting embodiments of the present disclosure provide a wide bandwidth dual-mode sonar transducer with controllable resonance frequencies disposition. The sonar transducer implements a pre-stressed piezoelectric transducer architecture, which includes an acoustic radiating piston, a head mass, a piezoelectric stack, a tail mass, and a non-uniform central fastener having a non-uniform profile. As described herein, a non-uniform profile or “variable profile” refers to: a varying shape of the fastener, varying materials used to form the fastener, and/or a varying stiffness (e.g., structural and/or elastic), all along the length of the fastener. For example, the non-uniform central fastener may have a non-uniform shape extending along its length, which is defined by one or both of a central groove and opposing flanges. The locations of the central groove and/or opposing flanges adjust or modify the first and second harmonics (e.g., of a sonar), respectively. In this manner, a dual-mode sonar transducer is provided that has a wider bandwidth compared to conventional sonar transducer, while still allowing controllable resonance frequencies disposition.

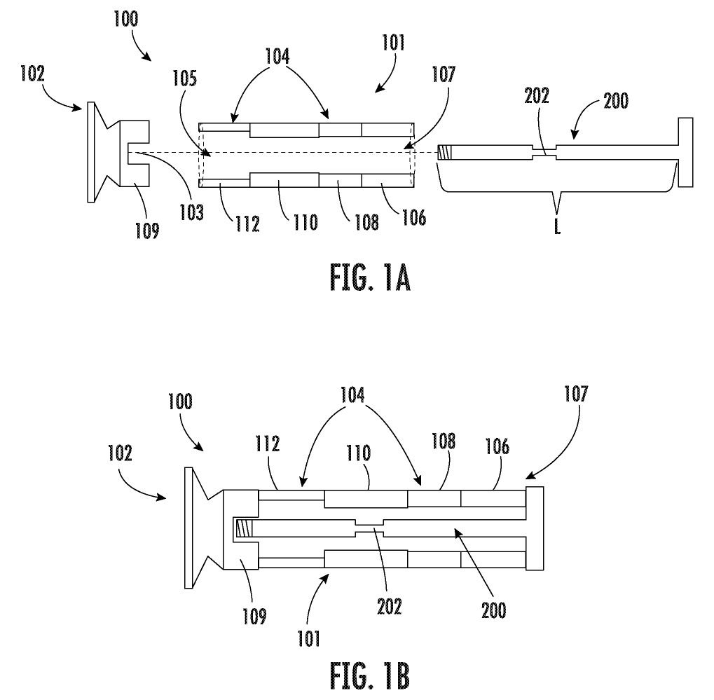

FIG. 1A depicts a separated view of a sonar transducer 100 according to a non-limiting embodiment of the present disclosure. The sonar transducer 100 includes an acoustic radiating piston 102, a transducer assembly 101, and a non-uniform central fastener 200. The acoustic radiating piston 102 is configured to operate as an acoustically radiating and receiving element. The acoustic radiating piston 102 may be formed from various metals including, but not limited to, aluminum and titanium. The acoustic radiating piston 102 may also have various profiles including, but not limited to, conical, circular, square, rectangular, flat, curved or tapered and is configured to be in contact with a surrounding medium (e.g., a protective and/or acoustical matching layer, gas, fluid, etc.).

In one or more embodiments, the acoustic radiating piston 102 is integrally formed with a head mass 109, which includes a hole 103 configured to receive a receiving end of the non-uniform central fastener 200. In a non-limiting embodiment, the hole 103 includes threaded sidewalls, which are configured to engage threads on the receiving end of the central fastener 200 and allows the non-uniform central fastener 200 to be screwed and tightened.

The transducer assembly 101 defines a first opening 105 located at a first end for receiving the head mass 109 and a second opening 107 located at the opposing second end to receive the non-uniform central fastener 200. The transducer assembly 101 includes a piezoelectric stack 104, a tail mass 106, and a middle mass 110 and is configured to operate as a transduction drive system for the sonar transducer 100.

The piezoelectric stack 104 includes a first piezoelectric element 108 and a second piezoelectric element 112. According to a non-limiting embodiment, the first piezoelectric element 108 and the second piezoelectric element 112 have different electrical characteristics (e.g., capacitance, etc.) and/or structural characteristics (e.g., length, thickness, etc.), to provide “piezo” asymmetry for both 1st and 2nd modes of excitation. The first and second piezoelectric elements 108 and 112 may be electrically connected in series or parallel and can operate in various deformation modes including, but not limited to, mode 31 and mode 33. The first and second piezoelectric elements 108 and 112 may also have various shapes including, but not limited to, extensional bars, discs, rings and cylinders. The first and second piezoelectric elements 108 and 112 are formed from a piezoelectric ceramic including, but not limited to, lead zirconate titanate (PZT). It should be appreciated, however, that the first and second piezoelectric elements 108 and 112 may be formed from other piezoelectric materials including, but not limited to, piezoelectric polymers, piezoelectric single crystals, and composite piezoelectric materials. Although two piezoelectric elements 108 and 112 are shown, it should be appreciated that more or less piezoelectric elements may be implemented without departing from the scope of the present disclosure.

The first and second piezoelectric elements 108 and 112 operate to convert output electrical signals into mechanical vibrations (e.g., acoustic waves) radiated from the acoustic radiating piston 102 and to convert mechanical vibrations received at the acoustic radiating piston 102 into input electrical signals. In an underwater sonar application, for example, the first and second piezoelectric elements 108 and 112 deform (e.g., move or vibrate) in response to receiving an applied electrical voltage. The deformation generates acoustic waves that propagate through the surrounding medium (e.g., water) to produce an acoustic transmission. Conversely, the first and second piezoelectric elements 108 and 112 deform in response to acoustic waves received by the acoustic radiating piston 102. Their deformation produces mechanical vibrations, which are converted into electrical signals that may be processed by a controller (e.g., to determine the presence of an object).

The tail mass 106, the head mass 109, and the middle mass 110 (collectively referred to as mass elements 106, 109 and 110) may serve as conductive shims and may have various shapes including, but not limited to, extensional bars, discs, rings and cylinders. The mass elements 106, 109 and 110 may also be formed from a variety of dense metals or metal alloys including, but not limited to, tungsten, stainless steel, steel alloys, aluminum alloys, titanium, and lead. Although three mass elements 106, 109 and 110 are described, it should be appreciated that more or less mass elements may be implemented without departing from the scope of the present disclosure. In the examples described herein, the middle mass 110 is sandwiched between the first piezoelectric element 108 and the second piezoelectric element 112. In some embodiments, however, the middle mass 110 may be omitted such that the first and second piezoelectric elements 108 and 112 are stacked directly against one another.

The mass elements 106, 109 and 110 are employed to apply an intended influence upon the mechanical and acoustic properties of the piezoelectric stack 104. For example, the material and profile of the mass elements 106, 109 and 110 can be designed so that the piezoelectric stack 104 is “tuned” to operate at a targeted resonance, while also providing impedance matching and mechanical stability.

The non-uniform central fastener 200 (also referred to as a “non-uniform bolt”) is fitted through the piezoelectric stack 104 to apply a pre-stress (e.g., a compression force) on the piezoelectric stack 104, e.g., the piezoelectric elements 108 and 112, and the mass elements 106, 109 and 110. The non-uniform central rod 200 may be formed as various types of fasteners including, but not limited to, a rod, a bolt, a shaft. Various metals can be used to form the non-uniform central fastener 200 including, but not limited to, stainless steel, aluminum, and titanium.

As described further below, the non-uniform central fastener 200 has a non-uniform profile that is achieved by varying the shape, the fastener material, and/or the stiffness along its length (L). In the example shown in FIGS. 1A and 1B, the non-uniform central fastener 200 achieves a non-uniform profile by having a groove 202 formed at its center, which changes the shape (e.g., thickness) and the stiffness along its length. The groove 202 serves as a “node” of the first fundamental resonance of the sonar transducer 100 (e.g., the (e.g., the non-uniform central fastener 200). As described herein, a node is a region or point on the non-uniform central fastener 200 having zero mechanical displacement at the resonance and at the same time maximum stress to induce a location of vibration or a “vibrational node”.

As shown in FIG. 1B, the sonar transducer 100 is assembled by coupling together, the tail mass 106, the first piezoelectric element 108, the middle mass 110, the second piezoelectric element 112, the head mass 109 and the acoustic radiating piston 102. In a non-limiting embodiment, the coupling is achieved by feeding the non-uniform central fastener through the tail mass 106, the first piezoelectric element 108, the middle mass 110 and the second piezoelectric element 112 so that its threaded receiving end is disposed in the threaded hole 103 of the head mass 109. The non-uniform central fastener 200 can then be tightened to couple together the tail mass 106, the first piezoelectric element 108, the middle mass 110, the second piezoelectric element 112, the head mass 109 and the acoustic radiating piston 102. Tightening together the non-uniform central fastener 200 and the head mass 109 also applies a pre-stress (e.g., a compression force) to the first and second piezoelectric elements 108 and 112.

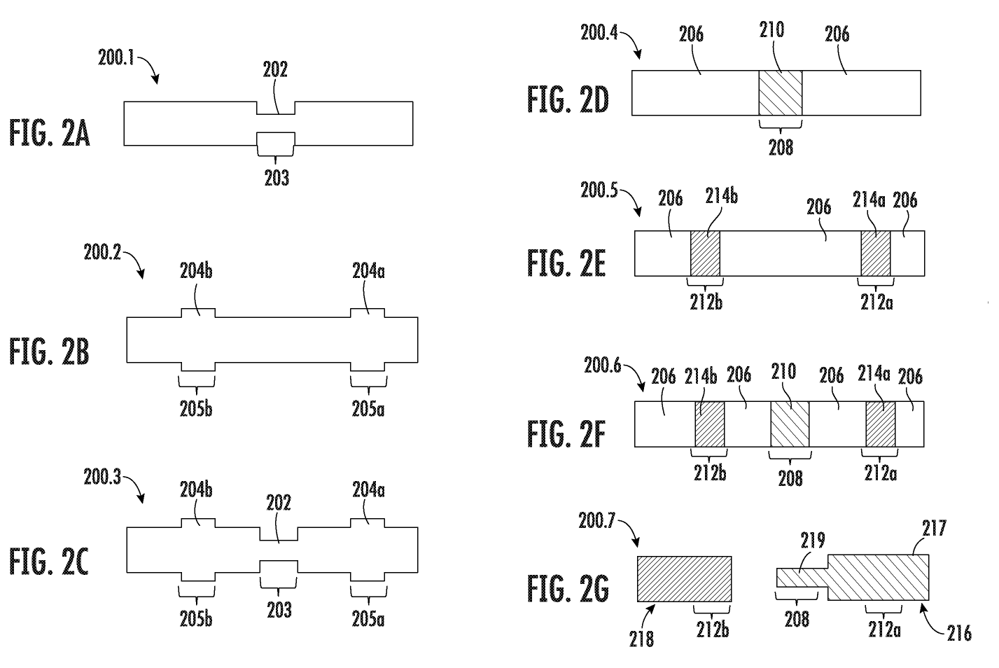

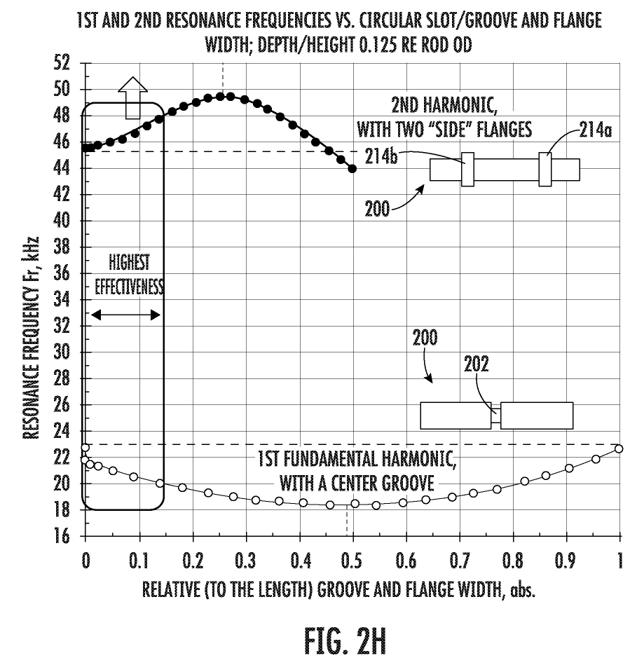

Turning now to FIGS. 2A through 2G, various non-uniform profiles of the central fastener 200 (e.g., 200.1-200.7) are illustrated according to non-limiting embodiments of the present disclosure. FIG. 2H is a diagram depicting a three-dimensional (3D) finite element analysis (FEA) simulation data for example 1st and 2nd resonance frequencies vs. circular center groove depth and lateral flanges widths. In the example, the simulations obtained using a non-uniform central fastener (e.g., non-uniform central fasteners 200.1 through 200.7) having an example length (L) of 4.4” (inches), and a shaft diameter is 0.30” (inches). The groove depth and flange height were taken at 1/8 (0.125) relative to the non-uniform central rod (e.g., non-uniform central fasteners 200.1 through 200.7).

With continued reference to FIG. 2H, the diagram depicts an increasing width of a center groove, with the 1st fundamental frequency decreasing from an initial point (original) to reach a minimum, before returning to the initial point. Conversely, the width of “side” flanges corresponding to the 2nd harmonic frequency increases from an initial point (original) and reaches a maximum, before returning back to the initial point. Both frequency shifts are determined by variation of material cross-section area through the groove or flange.

In addition, both effects and extrema are directly proportional to the depth of groove 202 and height of flanges 204a/204b, respectively. The largest practical limit for both depth of groove 202 and height of flanges 204a/204bis half of fastener radius, providing a tradeoff with necessary static structure pre-stressing. Referring to the example shown in FIG. 2H, the highest practical effectiveness, with lowering 1st fundamental frequency and increasing 2nd harmonic frequency, corresponds to the width up to 0.10, with structural upper limit 1/4 (0.25), of the fastener (transducer) length. According to a non-limiting embodiment, an increase in frequency bandwidth can reach 10% , and a cumulative effect up to 20%, with 2nd to 1st resonance frequencies ratio increasing from baseline 2 up to 2.4, and in some embodiments, up to 2.6.

Referring to FIGS. 2A through 2C, different variations of a machined non-uniform central fastener 200.1 through 200.3 are illustrated to non-limiting embodiments of the present disclosure.

FIG. 2A illustrates a first machined non-uniform central fastener 200.1 having a groove 202 formed at its central region 203. In a non-limiting embodiment, the groove 202 may be formed using a subtracting manufacturing process such as, for example, milling or grinding. In a non-limiting embodiment, the location of the groove 202 is near at the center of non-uniform central fastener 200.1 (e.g., at the vibrational node area corresponding to the first fundamental resonance). The groove 202 may have a depth ranging, for example, from low practical 0.1 0.03” inches to 0.5 0.08 inches with respect to the diameter of the non-unform central fastener (as an example here, for fastener length 4.4” with diameter 0.30”); and may have a groove length (e.g., extending parallel with the length of the non-uniform central fastener 200) can range, for example, from a thin circular slot 0.01 inches, with technically optimal 0.30”, up to 0.150 0.7 inches of the total shaft length (L).

The reduced thickness of the groove 202 reduces the stiffness (e.g., structural stiffness) corresponding to the first fundamental resonance node (e.g., first fundamental sonar resonance node) located at the central region 203 of the non-uniform central fastener 200.1 and decreases the first fundamental resonance. Accordingly, the non-uniform central fastener 200.1 has a non-uniform profile shape (e.g., a non-uniform thickness and non-uniform stiffness) along its length. The non-profile shape can include, but is not limited to, a square shape, conical shape and preferred rounded shape to reduce stress concentration under static pre-stress.

FIG. 2B illustrates a second machined non-uniform central fastener 200.2 having a first flange 204a and a second flange 204b. The first flange 204a and the second flange 204b can be formed at the two opposing second resonance nodes, which are located at lateral regions 205a and 205b, a distance away from the opposing ends of the non-uniform central fastener 200.2. The first and second flanges 204a and 204b serve as a “nodes” of the second resonance (e.g., the second overtone resonance) of the sonar transducer 100 (e.g., the non-uniform central fastener).

As described herein, a node is a region or point on the non-uniform central fastener 200 having zero mechanical displacement and at the same time maximum stress to induce a location of vibration or a “vibrational node”. The groove 202 may have a height ranging, for example, from 0.03” inches to 0.10 inches, with respect to the diameter of the non-unform central fastener (as an example here, for fastener length 4.4” with diameter 0.30”). According to a non-limiting embodiment, the first and second flanges 204a and 204b have a length (e.g., parallel with the length of the non-uniform central fastener central 200) ranging, for example, from low practical 0.10 0.01 inches, with technical optimal 0.30”, up to 0.150 0.7” inches, (as an example here, for fastener length 4.4” with diameter 0.30”). The first and second flanges 204a and 204b can have any suitable shape and profile that sufficiently adds material and stiffness to the lateral regions 205a and 205b.

The increased material of the first and second flanges 204a and 204b increases the stiffness (e.g., structural stiffness) of the non-uniform central fastener 200.2 at the lateral locations 205a and 205b corresponding to the second resonance nodes (e.g., second sonar resonance nodes), thereby increasing the second resonance frequency. Accordingly, the non-uniform central fastener 200.2 has a non-uniform profile shape (e.g., a non-uniform thickness and non-uniform stiffness) along its length.

FIG. 2C illustrates a third machined non-uniform central fastener 200.3 having the groove 202, along with the first and second flanges 204a and 204b. The central groove 202 reduces the fastener thickness of first fundamental resonance node located at the central region 203 thereby decreasing the first fundamental resonance, while the first and second flanges 204a and 204b increase the fastener thickness of the second resonance nodes located at the lateral regions 205a and 205b thereby increasing the second resonance frequency. Accordingly, the central groove 202, the first flange 204a and the second flange 204b define a non-uniform profile shape (e.g., a non-uniform thickness and non-uniform stiffness) along the length of the non-uniform central fastener 200.3.

FIGS. 2D through 2F illustrate different variations of a sectioned non-uniform central fastener 200.4 through 200.6. The different variations can be achieved, for example, by manufacturing the non-uniform central fasteners 200.4 through 200.6 with a traditional fastener material (e.g., stainless steel), but also incorporating sections of different materials having a stiffness (e.g., elastic stiffnesses) that is greater or less than the stiffness (e.g., elastic stiffnesses) of the fastener material. In a non-limiting embodiment, three-dimensional (3D) additive manufacturing (e.g., 3D printing) can be used to form the sections of different materials with respect to the fastener material at locations corresponding to the first fundamental resonance nodes and/or the second resonance nodes with respect to remaining locations of the fastener.

According to a non-limiting, a bi-metallic 3D printing technique can be utilized to combine two or more different metals to manufacture a single, typically stronger, structure. For example, a combined materials variant may include a main body material, a center material, and side materials. The main body material of the non-uniform central fastener 200.x can be middle-stiffness metal ranging from 180 GPa to 200 GPa), such as stainless steel and its alloy. The center material (e.g., used to form the 1st mode node at the fastener center) has a less stiffness than the main body material (near 2 times, for ex.). The stiffness can range, for example, from 70 GPa to 110 GPa, and includes metals such as titanium and its alloys (Y 110 GPa), Aluminum alloy (Y 70 GPa), and copper (Y 105 MPa). The side material e.g., used to form the two lateral 2nd mode nodes) have a higher stiffness than the main body material (near 2 times, for example). The side materials can be formed from metal having a stiffness greater than 200 GPa, and even greater than 400 GPa. In an example, the side materials are formed from tungsten and its alloys have a stiffness of about (Y 420 GPa).

FIG. 2D illustrates a non-uniform central fastener 200.4 formed from a fastener material 206 (e.g., a first material), but having a central section 208 formed from a different material 210 (e.g., a second material) that is located at the first fundamental resonance node. The central section 208 can be formed to have different shapes and profiles without departing from the scope of the present disclosure. In a non-limiting embodiment, the fastener material 206 has a first stiffness (e.g., elastic stiffnesses) and the material 210 of the central section 208 has a second stiffness (e.g., elastic stiffnesses) that is less than the stiffness (e.g., elastic stiffnesses) of the fastener material 206. For example, the first material may be stainless steel having an elastic stiffness ranging from about 193 gigapascals (GPa) to about 205 GPa, while the second material may be aluminum having an elastic stiffness ranging from about 68 GPa to about 70 GPa. Accordingly, the sections of different materials 206 and 210 define a non-uniform profile shape (e.g., a non-uniform material and non-uniform stiffness) along the length of the non-uniform central fastener 200.4.

FIG. 2E illustrates a non-uniform central fastener 200.5 formed from a fastener material 206 (e.g., a first material), but having two lateral sections 212a and 212b located at the second resonance nodes and formed from a different material 214a and 214b (e.g., a second material) different from the fastener material 206. The two lateral sections 212a and 212b can be formed to have different shapes and profiles without departing from the scope of the present disclosure. In a non-limiting embodiment, the fastener material 206 is a metal having a first stiffness (e.g., elastic stiffness) and the second material 214a and 214b is a metal having a second stiffness (e.g., elastic stiffness) that is greater than the first stiffness of the fastener metal 206 such as for example tungsten, with its stiffness of about 420 gigapascals (GPa).

In another example, the fastener material 206 may be stainless steel having an elastic stiffness ranging from about 193 gigapascals (GPa) to about 205 GPa, while the second material 214a and 214b may be carbon steel having an elastic stiffnesses ranging from 210GPa to about 212GPa. According to another non-limiting embodiment, different materials having an elastic stiffness greater than the fastener material can be formed at the lateral sections 212a and 212b corresponding to the second resonant frequency nodes. For example, a first lateral material 214a having an elastic stiffness greater than the fastener material can be formed at the first lateral section 212a, while a second lateral material 214b different from the first lateral material 214a and also having an elastic stiffness greater than the fastener material 206 can be formed at the second lateral section 212b. In either scenario, the sections of different materials 206, 214a and 214b define a non-uniform profile shape (e.g., a non-uniform material and a non-uniform stiffness) along the length of the non-uniform central fastener 200.5.

FIG. 2F illustrates a non-uniform central fastener 200.6 formed from a fastener material 206 (e.g., a first material), but having a central section 208 located at the first fundamental frequency node and two lateral sections 212a and 212b located at the second resonance nodes. The central section 208 is formed from a center material 210 (e.g., a second material) different from the fastener material 206, and the lateral sections 212a and 212b are formed from a lateral material 214a and 214b (e.g., a third material) different from both the fastener material 206 and the center material 210.

In a non-limiting embodiment, the fastener material 206 is a first metal having a first stiffness (e.g., elastic stiffness), the center material 210 is a second metal having a second stiffness (e.g., elastic stiffness) that is less than the first stiffness of the first metal 206, and the lateral material 214a and 214b is a third metal having a third stiffness (e.g., elastic stiffness) that is greater than the first stiffness of the first metal. As described herein, the lateral sections 212a and 212b can be formed with an elastic stiffness that is greater that the elastic stiffness of the fastener material 206 using either the same type of lateral material 214a and 214b or two different types of lateral materials 214a and 214b. Accordingly, the sections of different materials 206, 210, 214a and 214b define a non-uniform profile shape (e.g., a non-uniform material and a non-uniform stiffness) along the length of the non-uniform central fastener 200.6.

FIG. 2G illustrates a separated non-uniform central fastener 200.7, which includes a rear fastener portion 216 and a separate front fastener portion 218. The rear fastener portion 216 and the front fastener portion 218 can be independently manufactured with respect to one another. In this manner, the rear fastener portion 216 can be manufactured to have a first shape and/or first material, while the front fastener portion 218 can be manufactured to have a second shape different from the first shape and a second material different from the first material. As described herein, a bi-metallic 3D printing technique can be utilized to combine two or more different metals with different stiffnesses to manufacture the rear fastener portion 216 and the separate front fastener portion 218.

In a non-limiting embodiment, the rear fastener portion 216 includes a rear end 217 and an extended portion 219. The rear end 217 has a first thickness and encompasses a first lateral section 212a. The front fastener portion 218 has a thickness (e.g., third thickness) that matches, or substantially matches, the second thickness of the rear end 217 and encompasses a second lateral section 212b. In a non-limiting embodiment, the front fastener portion 218 and the rear end 217 are shaped or formed as extensional bars. It should be appreciated that other shapes or profiles can be used without departing from the scope of the present disclosure. The extended portion 219 has a second thickness that is less than the first thickness and encompasses a central section 208. Accordingly, the extended portion 219 reduces the fastener thickness at the first fundamental resonance node located at the central section 208, while the rear end 217 and the front fastener portion increase the fastener thickness at the second resonance nodes located at the lateral sections 212a and 212b.

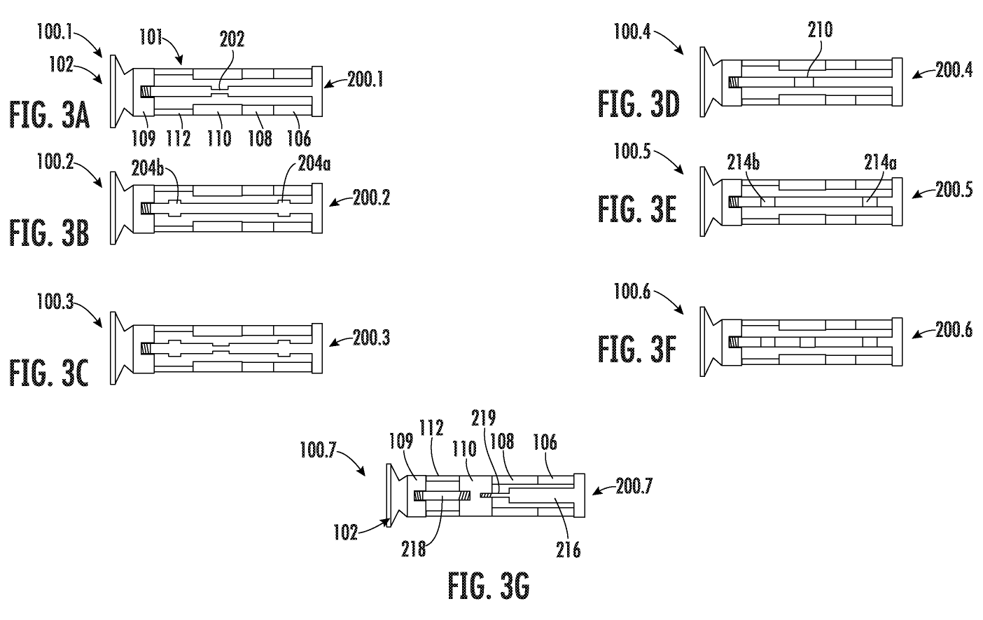

FIGS. 3A-3G, depict various assembled sonar transducers 100.1-100.7 implementing the different variations of the non-uniform central fastener 200.1-200.7 shown in FIGS. 2A-2G.

FIG. 3A depicts a sonar transducer 100.1 implementing the first machined non-uniform central fastener 200.1 having a groove 202 to reduce the stiffness (e.g., structural stiffness) at the first fundamental resonance node located at the center.

FIG. 3B depicts a sonar transducer 100.2 implementing the second machined non-uniform central fastener 200.2 having a flanges 204a and 204b to increase the stiffness (e.g., structural stiffness) at the second resonance node located at the central region 203.

FIG. 3C depicts a sonar transducer 100.3 implementing the third machined non-uniform central fastener 200.3 having a groove 202 and flanges 204a and 204b. The groove 202 reduces the fastener thickness of first fundamental resonance node located at the central region 203, while the first and second flanges 204a and 204b increase the fastener thickness of the second resonance nodes located at the lateral regions 205a and 205b.

FIG. 3D depicts a sonar transducer 100.4 implementing the third machined non-uniform central fastener 200.4 formed from a fastener material 206 (e.g., a first material), but having a central section 208 formed from a different material 210 (e.g., a second material) that is located at the first fundamental resonance node.

FIG. 3E depicts a sonar transducer 100.5 implementing the first sectioned non-uniform central fastener 200.5 formed from a fastener material 206 (e.g., a first material), but having two lateral sections 212a and 212b located at the second resonance nodes and formed from a different material 214a and 214b (e.g., a second material) different from the fastener material 206.

FIG. 3F depicts a sonar transducer 100.6 implementing the second sectioned non-uniform central fastener 200.6 formed from a fastener material 206 (e.g., a first material), but having a central section 208 located at the first fundamental frequency node and two lateral sections 212a and 212b located at the second resonance nodes. The central section 208 is formed from a center material 210 (e.g., a second material) different from the fastener material 206, and the lateral sections 212a and 212b are formed from a lateral material 214a and 214b (e.g., a third material) different from both the fastener material 206 and the center material 210.

FIG. 3G depicts a sonar transducer 100.7 implementing the separated non-uniform central fastener 200.7. As described above, the separated non-uniform central fastener 200.7 includes a rear end 217 and an extended portion 219. The rear end 217 has a first thickness and encompasses a lateral section 212a. The extended portion 219 has a second thickness that is less than the first thickness and encompasses a central section 208. The front fastener portion 218 has a thickness (e.g., third thickness) that matches, or substantially matches, the second thickness of the rear end 217 and encompasses a lateral section 212b. Accordingly, the extended portion 219 reduces the fastener thickness at the first fundamental resonance node located at the central section 208, while the rear end 217 and the front fastener portion 218 increase the fastener thickness at the second resonance nodes located at the lateral sections 212a and 212b.

In a non-limiting embodiment, the sonar transducer 100.7 implements a middle mass 110 that is coupled to the rear fastener portion 217 and the front fastener portion 218. For example, the middle mass 110 can include a rear threaded hole and a front threaded hole. The extended portion 219 of the rear fastener portion 216 includes a first threaded end and the front fastener portion 218 includes a second threaded end. The first threaded end of the extended portion 219 is inserted into the first threaded hold of the middle mass 110 and screwed in place. Likewise, the second threaded end of the front fastener portion 218 is inserted into the second threaded hold of the middle mass 110 and screwed in place. Accordingly, the tail mass 106, the first piezoelectric element 108, the middle mass 110, the second piezoelectric element 112, the head mass 109 and the acoustic radiating piston 102 can be coupled together. Tightening together the extended portion 219 and the front fastener portion 218 to the middle mass 110 also applies a pre-stress (e.g., a compression force) to the first and second piezoelectric elements 108 and 112. In a non-limiting embodiment, the ability to independently tighten or loosen the first fastener portion 218 and/or the extended portion 219 allows for independently adjusting the pre-stress applied to the first and second piezoelectric elements 108 and 112.

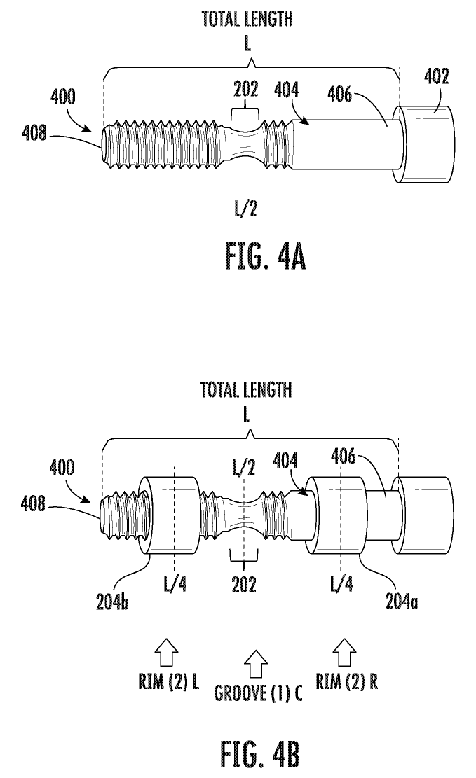

Turning now to FIG. 4A, a machined non-uniform bolt 400 is illustrated according to a non-limiting embodiment. The machined non-uniform bolt 400 includes a head 402, a body 404, and a groove 202. The body 404 can be formed as monolithic body that extends from a first end 406 coupled to the head 402 to an opposing second end 408 to define a bolt length (L). The body 404 includes threads formed on at least portion thereof, which can engage a threaded hole formed in a head mass (not shown in FIG. 4A). The machined non-uniform bolt 400 further includes a groove 202 located at the center (L/2) or central region of the body 404, and may serve as a “node” of the first fundamental resonance. The groove 202 reduces the thickness of the bolt 400 at the center (L/2) compared to the thickness of the body 404.

FIG. 4B illustrates a machined non-uniform bolt 410 according to another non-limiting embodiment. The machined non-uniform bolt 410 includes a head 402 and a body 404. The body 404 can be formed as monolithic body that extends from a first end 406 coupled to the head 402 to an opposing second end 408 to define a bolt length (L). The body 404 further includes threads formed on at least portion thereof, which can engage a threaded hole formed in a head mass (not shown in FIG. 4B).

The machined non-uniform bolt 410 further includes a groove 202 and flanges 204a and 204b. The groove 202 is located at the center (L/2) or central region of the body 404, and may serve as a “node” of the first fundamental resonance. The groove 202 reduces the thickness and stiffness of the bolt 400 at the center (L/2) compared to the thickness and thickness of the remaining body 404. The first and second flanges 204a are formed at the two opposing second resonance nodes, which are located at lateral regions (L/4), about half the distance away from the center (L/2) of the body 404. The increased thickness of the first and second flanges 204a and 204b increases the stiffness (e.g., structural stiffness) of the non-uniform central fastener 200.2 at the lateral locations (L/4) of the second resonance nodes, compared to the thickness and stiffness of the remaining body 404.

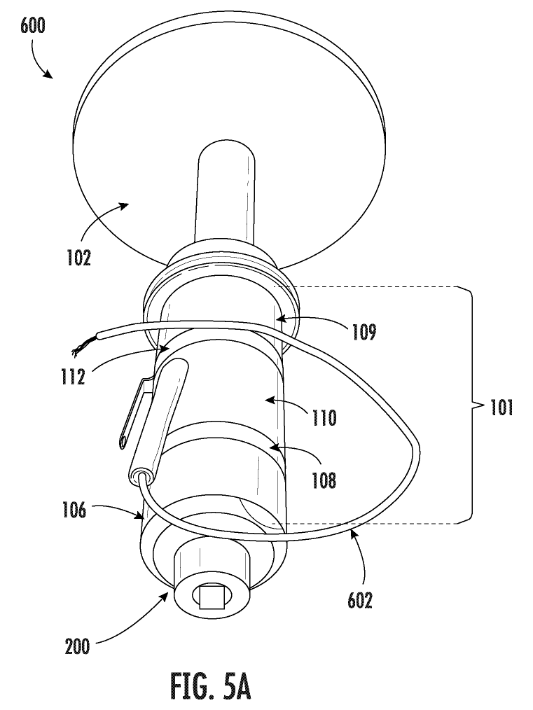

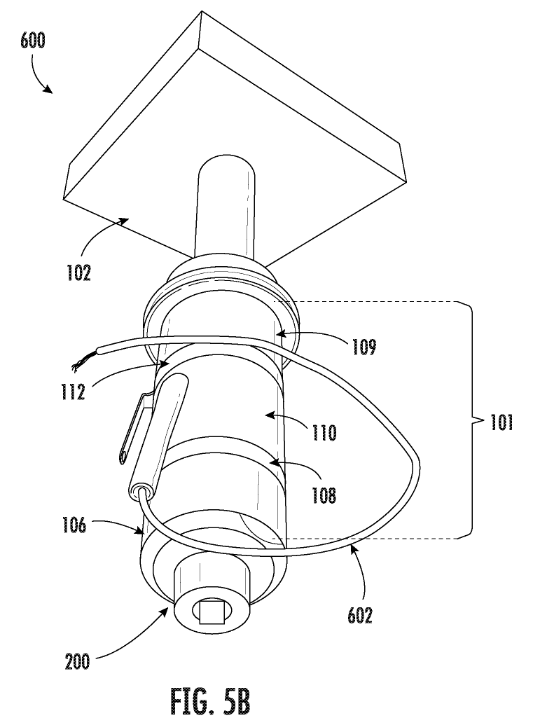

FIG. 5A is a perspective view of an assembled sonar transducer 600 according to a non-limiting embodiment of the present disclosure. The sonar transducer 600 The sonar transducer 600 includes an acoustic radiating piston 102, a transducer assembly 101, and a non-uniform central fastener 200. The acoustic radiating piston 102 is configured to operate as an acoustically radiating and receiving element. The acoustic radiating piston 102 may be formed from various metals including, but not limited to, aluminum and titanium. In this example, the acoustic radiating piston 102 is formed as a circular plate 102. In another example shown in FIG. 5B, the acoustic radiating piston 102 is formed as a square plate 102.

In one or more embodiments, the acoustic radiating piston 102 is integrally formed with a head mass 109 to be tightened together with the non-uniform central fastener 200. The central fastener 200 can be formed as any of the central fasteners (200.1-200.7) shown in FIGS. 2A-2G.

The piezoelectric stack 104 includes a first opening 105 located at a first end for receiving the head mass 109 and a second opening 107 located at the opposing second end to receive the non-uniform central fastener 200. The piezoelectric stack 104 is configured to operate as a transduction drive system for the sonar transducer 100. The piezoelectric stack 104 includes a tail mass 106, a first piezoelectric element 108, a middle mass 110, and a second piezoelectric element 112. The sonar transducer 600 may further include a signal line 602. The signal line provides an electrical voltage to stimulate and vibrate the first and second piezoelectric elements 108 and 112, which produce mechanical vibrations that are radiated from the acoustic radiating piston 102. Conversely, the first and second piezoelectric elements 108 and 112 deform in response to acoustic waves received by the acoustic radiating piston 102. Their deformation produces mechanical vibrations that cause the piezoelectric elements 108 and 112 to generate electrical signals, which are delivered to the signal line 602.

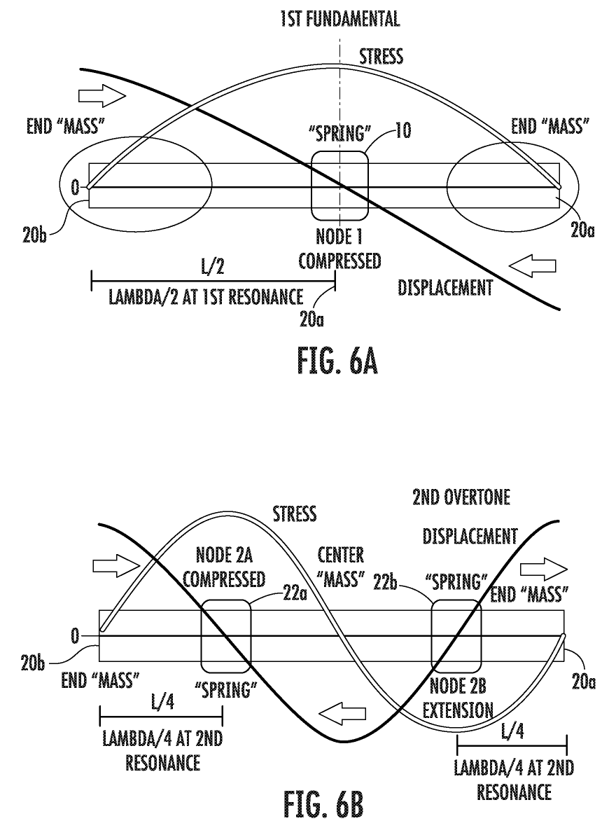

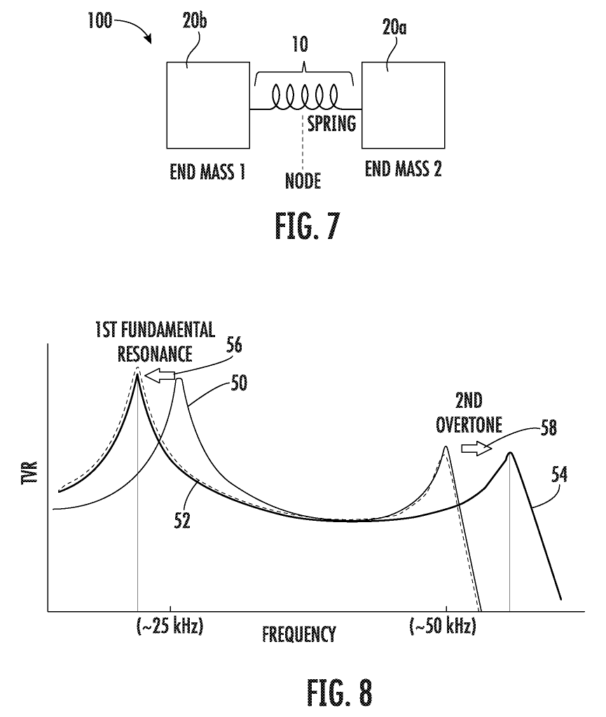

FIGS. 6A and 6B, with reference also to FIGS. 4B and 7, illustrate diagrams depicting the dual vibrational modes of a sonar transducer 100 implemented with a non-uniform central fastener. The diagrams shown in FIG. 6A and 6B describe the vibrational modes of a sonar transducer 100 implementing a machined non-uniform central fastener 410, with respect to corresponding locations of the first fundamental resonance node and the second resonance nodes (e.g., the second overtone resonance nodes).

When operating at the first fundamental resonance, maximum stress applied to the non-uniform central fastener 410 is present at the fastener central region (L/2 of the total fastener length (L)), where the vibrational node defined by the groove 202 is located. The central localized node acts as a “spring” 10 with maximum deformation due to the reduced thickness of the groove 202, and both ends behave as a load “mass” 20a and 20b, as depicted in the “spring-mass” simple model shown in FIG. 7. At the lateral second resonance locations, maximum stress is closer to the fastener ends 406 and 408 (L/4 from the both ends), where its vibrational second resonance nodes are located due to the increased thickness provided by the flanges 204a and 204b.

The dual vibrational modes described above facilitates a bandwidth widening effect provided by a sonar transducer 100 provided by non-limiting embodiments of the present disclosure. Referring to the diagram shown in FIG. 8, for example, line 50 reflects a baseline vibration of a sonar transducer implementing a conventional uniform central fastener.

Lines 52 and 54 reflect the dual vibrations modes provided by the sonar transducer 100 implementing a non-uniform central fastener 200. The groove 202 reduces the stiffness at the central region (L/2) of the non-uniform central fastener 200, thereby lowering the fundamental resonance as reflected by line 52. However, the flanges 204a and 204b increase the stiffness at the lateral regions (L/4), thereby increasing the second resonance frequency (e.g., the second overtone resonance) as reflected by line 54. In a non-limiting embodiment, the numerical ratio of the second resonance frequency with respect to the first resonance frequency can range 1 to 2.4, to 1 to 2.6, compared to the baseline is 1 to 2 (1:2), or approximately 1:2.

Arrows 56 and 58 indicate shifts of respective resonance frequencies of fundamental first order and the second order. In other words, the sonar transducer 100 implementing the non-uniform central fastener is capable of exciting at least two multiple resonant frequencies with addition thereof between the multiple resonant frequencies. Accordingly, the sonar transducer 100 can provide a dual vibration modes while operating at wider band response from below the first resonance to at least above the second resonance that is unattainable by conventual sonar transducer (reflected by line 50) implementing a uniform central fastener.

According to a non-limiting embodiment, a method is also provided for performing electro-mechanical transduction. The method comprises: providing an electro-mechanical drive member (e.g., a piezoelectric stack 104) coupled with a section of electrically inactive acoustic transmission line (e.g., a non-uniform central fastener 202); exciting said electro-mechanical transduction member to cause the excitation of at least two multiple resonant frequencies, at least one an odd and one an even mode, said excitation further causing the addition of said at least two multiple resonant frequencies so as to provide a wideband response in a range from below the first resonance to at least above the second resonance.

Technical effects and benefits of the present disclosure are the provision of systems and methods for dynamic PCM usage for heat removal from electronic devices. The systems and methods effectively add to the reliability of the electronic devices as the phase change process of the PCM dampens sudden temperature spikes.

The term “about” is intended to include the degree of error associated with measurement of the particular quantity based upon the equipment available at the time of filing the application. For example, “about” can include a range of ± 8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A sonar transducer comprising:
an acoustic radiating piston configured to emit and receive acoustic waves;
a piezoelectric stack comprising a plurality of piezoelectric elements, the piezoelectric stack being configured to convert output electrical signals into mechanical vibrations and convert received mechanical vibrations into input electrical signals;
a non-uniform central fastener having a body extending from a first end to a second end to define a fastener length, the non-uniform central fastener extending through the piezoelectric stack and applying a pre-stress to the piezoelectric stack,
wherein the non-uniform central fastener has a non-uniform profile along the fastener length.

2. The sonar transducer of claim 1, wherein the non-uniform profile includes a variation in stiffness along the fastener length.

3. The sonar transducer of claim 2, wherein the non-uniform profile comprises one or both of:
a groove formed at a central region of the non-uniform central fastener; and
a first flange formed at a first lateral region located adjacent a first end of the body and a second flange formed at a second lateral region located adjacent a second end of the body opposite the first end.

4. The sonar transducer of claim 3, wherein the central region corresponds to a vibrational node location of a first fundamental resonance of the non-uniform central fastener.

5. The sonar transducer of claim 4, wherein the body has a first thickness and a first structural stiffness, and the groove has a second thickness less than the first thickness and a second structural stiffness less than the first structural stiffness.

6. The sonar transducer of claim 5, wherein the first and second lateral regions correspond to vibrational node locations of a second resonance of the non-uniform central fastener.

7. The sonar transducer of claim 2, wherein the body has a first thickness and a first stiffness, and the first and second flanges each have a second thickness that is greater than the first thickness and each have a second stiffness that is greater than the first stiffness.

8. The sonar transducer of claim 7, wherein the non-uniform central fastener is configured to operate according to dual vibrational modes in response to resonating at the central region and at the first and second lateral regions.

9. The sonar transducer of claim 1, wherein the acoustic radiating piston is formed from metal.

10. The sonar transducer of claim 1, wherein the plurality of piezoelectric elements includes a first piezoelectric element and a second piezoelectric element, the first and second piezoelectric elements being electrically connected in one of series or parallel.

11. The sonar transducer of claim 3, wherein the groove has a depth ranging from 0.1 inches to 0.5 inches relative to a diameter of the fastener.

12. The sonar transducer of claim 3, wherein the first flange is located a distance of one-quarter of the length from the first end, and the second flange is located a distance of one-quarter of the fastener length from the second end.

13. The sonar transducer of claim 2, wherein the non-uniform central fastener comprises one or both of:
a central section of the body formed from a first material; and
a first lateral section of the body formed from a second material and a second lateral section of the body formed from the second material,
wherein the body is formed from a fastener material different from the first material and the second material.

14. The sonar transducer of claim 13, wherein the fastener material is a first metal having a first elastic stiffness, the first material is a second metal having a second elastic stiffness that is less than the first elastic stiffness, and the second material is a third metal having a third elastic stiffness that is greater than the first elastic stiffness.

15. The sonar transducer of claim 2, wherein the non-uniform central fastener comprises:
a front portion encompassing a first lateral region of the non-uniform central fastener;
a rear portion separated from the front portion, the rear portion including:
a rear end encompassing a second lateral region of the non-uniform central fastener; and
an extended portion of the body encompassing a central region of the non-uniform central fastener.

16. The sonar transducer of claim 15, wherein the front portion and the rear end have a first thickness and a first structural stiffness, and the extended portion has a second thickness less than the first thickness and a second structural stiffness that is less than the first structural thickness.

17. The sonar transducer of claim 8, wherein the dual vibrational modes include a first fundamental resonance mode and a second resonance mode, each of the first fundamental resonance mode and a second resonance mode being activated by the variation with stiffness along the fastener length.

18. The sonar transducer of claim 17, wherein the dual vibrational modes establish a frequency ratio between the first fundamental resonance mode and the second resonance mode higher than 1 to 2 (1:2).
